(19) United States
(12) Patent Application Publication
(10) Pub. No.: US 2012/0105375 A1
(43) Pub. Date: May 3, 2012

(54) ELECTRONIC DEVICE

(75) Inventor: Youji YAMADA, Yokohama-shi (JP)

(73) Assignee: KYOCERA CORPORATION, Kyoto (JP)

(21) Appl. No.: 13/280,772

(22) Filed: Oct. 25, 2011

(30) Foreign Application Priority Data
Oct. 27, 2010 (JP) 2010-241551

(51) Int. Cl. G06F 3/042; G06F 3/041

(52) U.S. Cl. 345/175; 345/173

(57) ABSTRACT

An electronic device includes a housing; a touch surface exposed to the surface of the housing; a displacement detector; a rotational movement detector; a linear movement detector; a signal generator; and a control unit. The displacement detector detects a displacement of an object touching the touch surface. The rotational movement detector detects a rotational movement of the object based on the displacement. The linear movement detector detects a linear movement of the object based on the displacement. The signal generator generates an operation signal corresponding to the rotational movement and the linear movement. The control unit controls an operation to be performed based on the operation signal.

This application claims priority from Japanese Application No. 2010-241551, filed on Oct. 27, 2010, the content of which is incorporated by reference herein in its entirety.

### BACKGROUND OF THE INVENTION

1. Technical Field

The present disclosure relates to an electronic device including an input unit.

2. Description of the Related Art

An electronic device, for example, a mobile electronic device such as a mobile phone, PDA, a portable navigation device, and a mobile game machine, and a fixed-type electronic device such as a personal computer (PC), is provided with an operating unit through which an operation is input. A keyboard, a touch panel, a mouse, or the like is provided as the operating unit.

A pointing device for mainly performing an operation on a cursor, a pointer, and an icon or the like includes a mouse, a lever, directional keys used to input directions of up, down, right, and left as described in Japanese Patent Application Laid-open No. 2009-295155, and a pointing device for detecting a change of a touch (movement of fingerprint ridge) on a touch surface (surface) as described in Japanese Patent Application Laid-open No. 2006-268852.

### SUMMARY

According to an aspect, an electronic device includes: a housing; a touch surface exposed to a surface of the housing; a displacement detector; a rotational movement detector; a linear movement detector; a signal generator; and a control unit. The displacement detector detects a displacement of an object touching the touch surface based on a light from the touch surface. The rotational movement detector detects a rotational movement of the object based on the displacement detected by the displacement detector. The linear movement detector detects a linear movement of the object based on the displacement detected by the displacement detector. The signal generator generates the first operation signal corresponding to the rotational movement detected by the rotational movement detector and generates the second operation signal corresponding to the linear movement detected by the linear movement detector. The control unit controls an operation to be performed based on the first operation signal and an operation to be performed based on the second operation signal.

### BRIEF DESCRIPTION OF THE DRAWINGS

FIG. 1 is a front view illustrating a mobile phone terminal;

FIG. 2 is a diagram illustrating a virtual keyboard displayed on a touch panel;

FIG. 3 is a cross-sectional view illustrating a schematic configuration of an input device;

FIG. 4 is a top view illustrating the schematic configuration of the input device;

FIG. 5 is an explanatory diagram for explaining one example of an input operation;

FIG. 6 is an explanatory diagram for explaining one example of the input operation;

FIG. 7 is a block diagram illustrating a schematic configuration of functions of the mobile phone terminal;

FIG. 8 is an explanatory diagram for explaining an operation of the input device;

FIG. 9 is an explanatory diagram for explaining an operation of the input device;

FIG. 10 is an explanatory diagram for explaining an operation of the input device;

FIG. 11 is an explanatory diagram for explaining an operation of the input device;

FIG. 12 is an explanatory diagram for explaining another example of the input operation;

FIG. 13 is an explanatory diagram for explaining an operation of the input device;

FIG. 14 is a flowchart illustrating one example of the operation of the mobile phone terminal;

FIG. 15 is an explanatory diagram for explaining an operation of the mobile phone terminal;

FIG. 16 is a front view illustrating a mobile phone terminal according to another embodiment; and

FIG. 17 is a side view of the mobile phone terminal illustrated in FIG. 16.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone terminal is used to explain as an example of the electronic device, however, the present invention is not limited to the mobile phone terminals. Therefore, the present invention can be applied to any type of devices provided with an input unit, including but not limited to a personal handyphone systems (PHS), personal digital assistants (PDA), portable navigation devices, personal computers (including but not limited to tablet computers, netbooks etc.), media players, portable electronic reading devices, and a gaming devices.

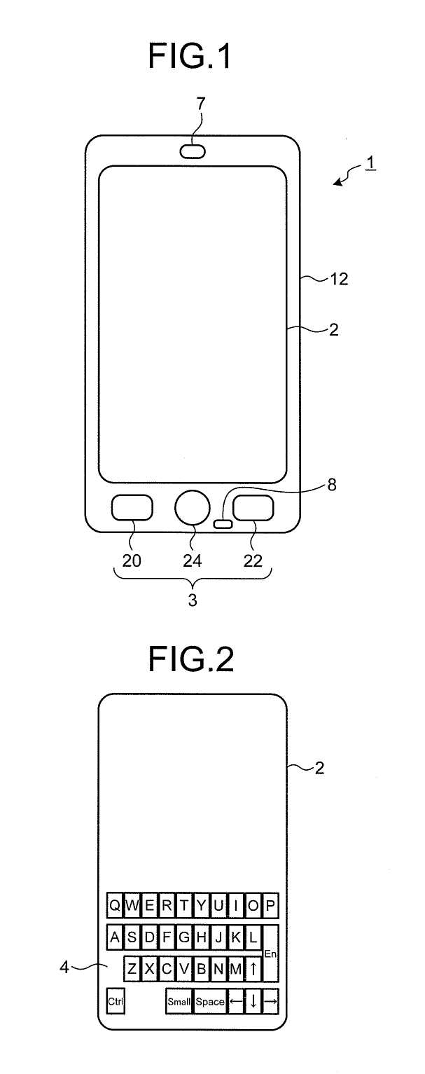

FIG. 1 is a front view illustrating an overall configuration of a mobile phone terminal 1 according to an embodiment of an electronic device. The mobile phone terminal 1 has a thin box-shaped housing 12. The mobile phone terminal 1 includes a touch panel 2; an input unit 3 including a button 20, a button 22, and an input device 24; a receiver 7; and a microphone 8, which are arranged on the surface of the housing 12. The touch panel 2 is provided over a face of housing 12. The input unit 3 is provided at one end of the face of the housing 12, in its long side direction, where the touch panel 2 is provided. The button 20, the input device 24, and the button 22 are arranged in the input unit 3 in this order from one end toward the other end in a short side direction of the housing 12. The receiver 7 is provided at the other end of the face of the housing 12, in the long side direction, where the touch panel 2 is provided, that is, at the end on the opposite side to the end where the input unit 3 is provided. The microphone 8 is provided at one end of the face of the housing 12 where the touch panel 2 is provided, that is, at the end where the input unit 3 is provided.

The touch panel 2 displays characters, graphics, images, and so on, and detects any of various operations (gestures) performed onto the touch panel 2 using finger (s), a pen, a stylus or the like (in the description herein below, for the sake of simplicity, it is assumed that the user touches the touch panel 2 and the touch sensor 4 with his/her fingers). FIG. 2 is a diagram illustrating a virtual keyboard displayed on the touch panel. For example, in order to receive an input of character from the user, the mobile phone terminal 1 displays a virtual keyboard 4 on the touch panel 2 as illustrated in FIG. 2. The mobile phone terminal 1 enables a character input by detecting any of the operations input to the touch panel 2 with the finger when the virtual keyboard 4 is displayed on the touch panel 2, detecting which key of the virtual keyboard 4 is touched, and determining that the key detected as being pressed or touched is a key used for the input. The touch panel 2 detects not only the input of the characters but also the input of the various operations based on a displayed image and the operation performed onto the touch panel 2 with the finger, and provides any of various controls based on the input operation.

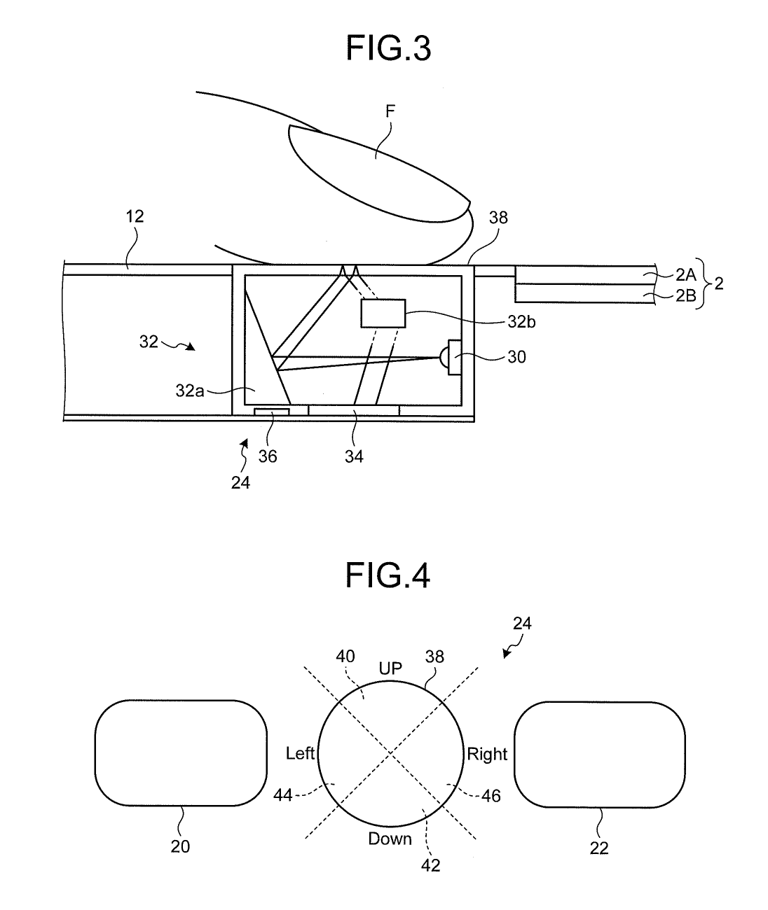

When the button 20 or 22 is pressed, the input unit 3 activates a function corresponding to the pressed button. The input unit 3 detects an operation input to the input device 24 as an operation, and provides any of the controls based on the input operation. A configuration of the input device 24 will be explained below with reference to FIG. 3 to FIG. 5. FIG. 3 is a cross-sectional view illustrating a schematic configuration of the input device, FIG. 4 is a top view illustrating the schematic configuration of the input device, and FIG. 5 is an explanatory diagram for explaining one example of the input operation.

The input device 24 includes a light source 30, an optical unit 32, a sensor 34, a processing unit 36, and a touch surface 38. The input device 24 detects and analyzes a movement of a finger F touching the touch surface 38 that is exposed to the surface of the housing 12, to detect the operation input by the finger F. In the present embodiment, the input operation is detected by the movement of the finger F, however, if an object can touch the touch surface 38 and a change of the touch, that is, a movement thereof can be detected, the object can be used as an object for inputting an operation. As the object, similarly to that for the touch panel 2, a finger, a stylus, and a pen or the like can be used. The touch surface 38 is formed with a material such that reflection characteristics of light changes in response to a touch of the object such as the finger F on the surface. The touch surface 38 has a circular-shaped exposed surface. The touch surface 38 is provided near the touch panel 2. The touch panel 2 is formed with a display unit 2B and a touch sensor 2A overlapped on the display unit 2B.

The light source 30 outputs a measurement light. A light-emitting diode (LED), a laser diode, or the like can be used as the light source. As the light source, it is preferable to use a light source that outputs a light with a predetermined wavelength, especially with a wavelength in an invisible region. By using the light with the wavelength in the invisible region, even if the light is emitted from the touch surface 38 to the outside, the light is not recognized, and the user is prevented from being dazzled by the light. Because the optical unit can be made simple, a light source that emits a highly directional light is preferably used.

The optical unit 32 is a mechanism forming an optical path along which the light output from the light source 30 is caused to reach the touch surface 38 and is then guided up to the sensor 34. The optical unit 32 includes a mirror 32a and an optical system 32b. The mirror 32a reflects the light output from the light source 30 to deflect the light toward the touch surface 38. The optical system 32b is formed with an optical member that converges and deflects the light, and deflects the light reflected by the touch surface 38 toward the sensor 34.

The sensor 34 is a light-detecting element that detects the light reflected by the touch surface 38. The sensor 34 has a planar detection surface, and detects a distribution of intensity of light incident on positions on the plane, to thereby acquire an image on the touch surface 38. The sensor 34 transmits the result (image) of detection to the processing unit 36. The processing unit 36 is a processing circuit, such as a digital signal processor (DSP), and detects a movement of the finger F based on the result of detection by the sensor 34. The processing unit 36 will be explained later.

The input device 24 is configured in the above manner. The optical unit 32 guides the measurement light output from the light source 30, to be reflected by the touch surface 38, and then causes the light to enter the sensor 34. Thereafter, the input device 24 transmits the information for the distribution of the light incident on the sensor 34 to the processing unit 36, where the result of detection is analyzed to detect a shape of the finger F (object) touching the touch surface 38. The input device 24 repeats the detection of the shape of the finger F touching the touch surface 38 at each given time, to detect a change of the shape of the finger F touching the touch surface 38, that is, a motion/movement of the finger F. By detecting the image of the finger F, the input device 24 detects irregularities (fingerprint or so) of the finger F, detects feature points from the fingerprint, and detects a movement of the feature points, so that the movement of the finger F can be detected. FIG. 3 illustrates a state in which only one location of the touch surface 38 is detected, however, an entire image on the touch surface 38 can be acquired (detected) by arranging a plurality of similar units.

As illustrated in FIG. 4, the input device 24 is set so that the area of the touch surface 38 is divided into a first area 40, a second area 42, a third area 44, and a fourth area 46. Assuming that the center of the touch surface 38 is set as a center and a point closest to the touch panel 2 is set as 0°, the first area 40 ranges from 315° to 45°. Likewise, the second area 42 ranges from 135° to 225°. The third area 44 ranges from 225° to 315°. The fourth area 46 ranges from 45° to 135°.

For example, when an image whose long side direction is set as a vertical direction is displayed on the touch panel 2, and if it is detected that the finger F (arbitrary feature points of the finger F) is moved from the first area 40 to the second area 42, the input device 24 determines that an instruction to move an operation target, such as a cursor, downward is input. As illustrated in FIG. 5, when the finger F moves in an a direction and it is detected that the finger F has moved from the third area 44 to the fourth area 46, the input device 24 determines that an instruction to move the operation target rightward is input. In this manner, by previously dividing the area into four areas and detecting from which area to which area the finger has moved, the input device 24 can determine in which of the four directions of up, down, right, and left the operation to move is input. In other words, the input device 24 can be appropriately used as a directional key.

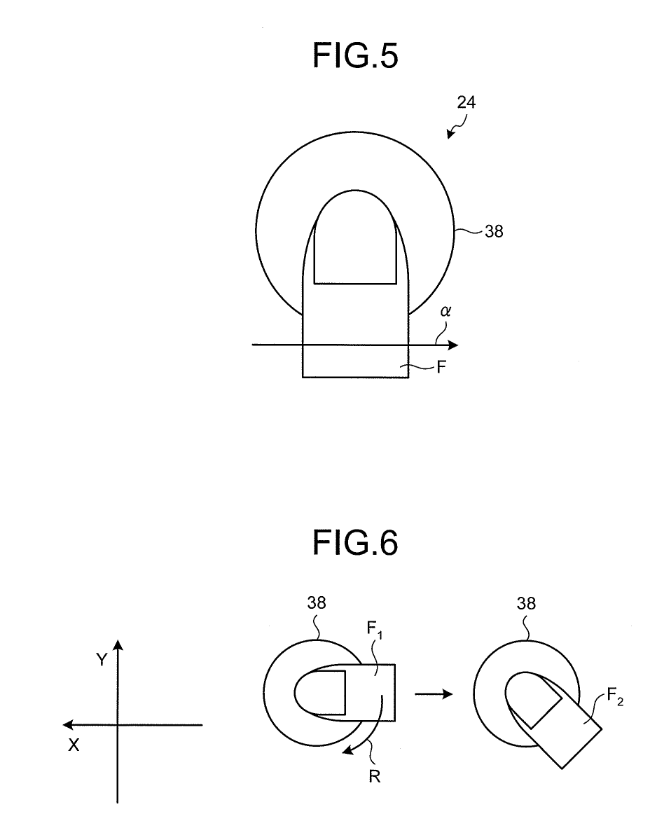

As illustrated in FIG. 6, when a finger F₁ touching the touch surface 38 of the input device 24 rotates in an R direction (clockwise) to move up to a finger F₂, the input device 24 detects a rotational movement of the finger and determines that the finger rotates clockwise. In this way, the input device 24 detects the rotational movement of the finger also as an operation. FIG. 6 illustrates an X axis indicating an X-axis direction and a Y axis indicating a Y-axis direction. These axes will be explained later.

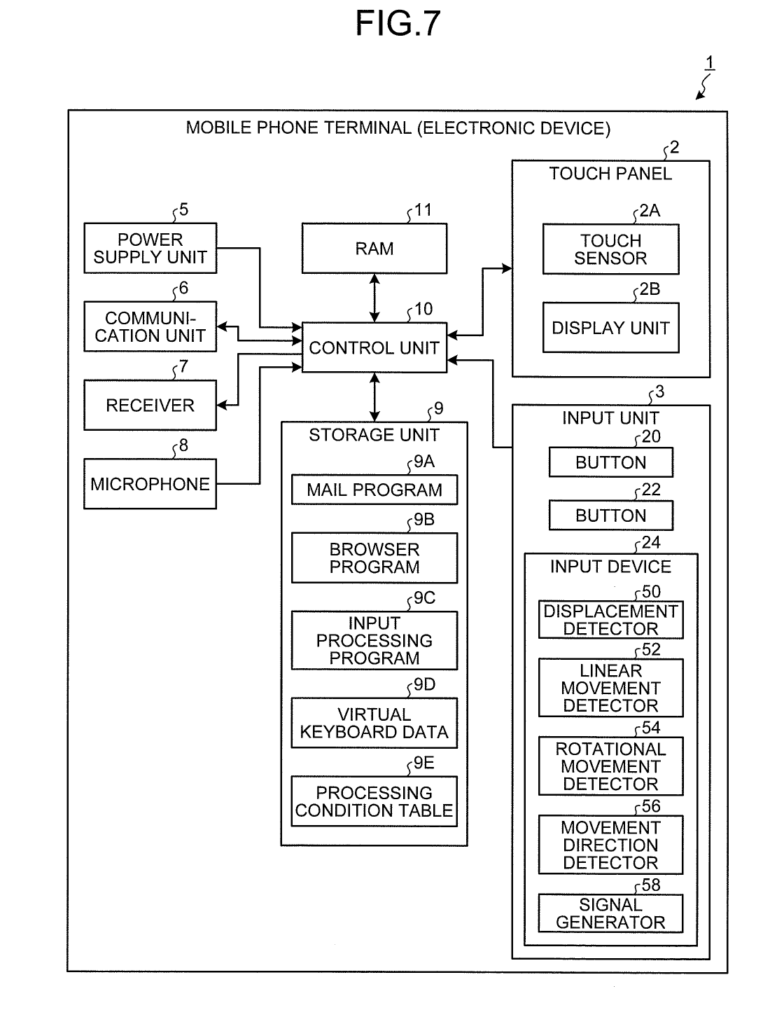

Next, a relationship between functions and a control unit of the mobile phone terminal 1 will be explained below. FIG. 7 is a block diagram illustrating a schematic configuration of functions of the mobile phone terminal 1 in FIG. 1. As illustrated in FIG. 7, the mobile phone terminal 1 includes the touch panel 2, the input unit 3, a power supply unit 5, a communication unit 6, the receiver 7, the microphone 8, a storage unit 9, a control unit 10, and a random access memory (RAM) 11.

The touch panel 2 includes the display unit 2B and the touch sensor 2A overlapped on the display unit 2B as explained above. The touch sensor 2A detects any of the operations (gestures) performed on the touch panel 2 using the finger as well as a position on the touch panel 2 where the operation is performed. The operations detected by the touch sensor 2A includes an operation of touching the finger on the surface of the touch panel 2, an operation of moving the finger with the finger kept touched on the surface of the touch panel 2, and an operation of releasing the finger therefrom. Any detection methods, including but not limited to, a pressure sensitive type detection method and a capacitive type detection method, may be adopted as the detection method of the touch sensor 2A. The display unit 2B is formed with, for example, a liquid crystal display (LCD) and an organic electro-luminescence (organic EL) panel, and displays characters, graphics, images, or the like.

The input unit 3 includes the buttons 20 and 22, and the input device 24. Each of the buttons 20 and 22 receives a user operation through a physical input (pressing), and transmits a signal corresponding to the received operation to the control unit 10. The input device 24 will be explained later.

The power supply unit 5 supplies electric power obtained from a battery or an external power supply to each of function units of the mobile phone terminal 1 including the control unit 10. The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The receiver 7 outputs speech of the other party on the telephone communication, a ring tone, or the like. The microphone 8 converts the speech of the user or somebody else to electrical signals.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. Specifically, the storage unit 9 stores therein a mail program 9A for browsing, transmitting and receiving of mail, a browser program 9B for browsing Web pages, an input processing program 9C for determining a control operation and a process based on an input operation input to the input device 24, a virtual keyboard data 9D including definition for the virtual keyboard 4 displayed on the touch panel 2 upon input of a character, and a processing condition table 9E including conditions in which an input operation detected in the input process and a control operation are associated with each other. The storage unit 9 also stores therein an operating system program for implementing basic functions of the mobile phone terminal 1, and other programs and data such as address book data in which names, telephone numbers, mail addresses, and the like are registered. In addition, the storage unit 9 stores therein programs and the like for determining a control operation and a process based on the input operation input to the touch panel 2. The control operation and the process includes various operations and processes implemented by the mobile phone terminal 1, which are, for example, movement of a cursor and a pointer, display switching of a screen, a character input process, and an activation process and an end process of various applications.

The control unit 10 is, for example, a central processing unit (CPU), and integrally controls the operations of the mobile phone terminal 1. Specifically, the control unit 10 executes the program(s) stored in the storage unit 9 while referring to the data stored in the storage unit 9 as necessary, and executes the various processes by controlling the touch panel 2, the input unit 3, and the communication unit 6, and the like. The control unit 10 loads the program stored in the storage unit 9 or the data acquired/generated/processed through execution of the processes to the RAM 11 that provides a temporary storage area, as required. The program executed by the control unit 10 and the data to be referred to may be downloaded from a server over wireless communication by the communication unit 6.

As illustrated in FIG. 7, the input device 24 includes a displacement detector 50, a linear movement detector 52, a rotational movement detector 54, a movement direction detector 56, and a signal generator 58. A part of the displacement detector 50, the linear movement detector 52, the rotational movement detector 54, the movement direction detector 56, and the signal generator 58 are function units for performing an arithmetic process, and are executed by processing units forming the processing unit 36. The functions of a part of the displacement detector 50, the linear movement detector 52, the rotational movement detector 54, the movement direction detector 56, and the signal generator 58 may be performed by one application software and program, or may be performed by respective application software and program for each function. In the present embodiment, the processing unit 36 and the control unit 10 are separately provided, however, both the functions may be performed by one processing unit. Alternatively, a part of the functions of the processing unit 36 may be performed by the control unit 10.

The displacement detector 50 includes the light source 30, the optical unit 32, the sensor 34, a part of the functions of the processing unit 36, and the touch surface 38. The displacement detector 50 acquires and analyzes an image on the touch surface 38 through the processes, to detect a displacement (movement) of the object. The displacement detector 50 performs detection (acquires polling data) at each given time (e.g., each 20 ms). If a change of the image on the touch surface or any touch is detected, the displacement detector 50 starts the process of detecting the displacement.

The linear movement detector 52 detects a linear movement of the object from the information for the image or the information for the displacement of the object detected by the displacement detector 50. The linear movement detector 52 detects a displacement amount at each unit time. If an integrated value of detected displacement amounts, that is, a movement amount of the object exceeds a given value, the linear movement detector 52 detects that the object has linearly moved. The linear movement detector 52 can set detection criteria of the linear movement as various settings. For example, if the integrated value of the movement amounts within the given time exceeds the threshold, it may be determined that the object has moved. Alternatively, if the displacement amount per unit time (an instantaneous value; a displacement amount detected at one detection) exceeds a given value, it may be determined that the object has moved. The linear movement detector 52 transmits the result of detection of the linear movement to the signal generator 58.

The rotational movement detector 54 detects a rotational movement of the object from the information for the image or the information for the displacement of the object detected by the displacement detector 50. A method of detecting a rotational movement by the rotational movement detector 54 will be explained later. The rotational movement detector 54 transmits the result of detection of the rotational movement to the signal generator 58.

The movement direction detector 56 detects a direction of the displacement detected by the displacement detector 50, and detects a direction of movement of the object. That is, the movement direction detector 56 detects from which of the first area 40 through the fourth area 46 to which of the first area 40 through the fourth area 46 the object has moved, and transmits the information for the detected movement direction to the signal generator 58. In addition, the movement direction detector 56 detects whether the object rotates clockwise or counterclockwise, and transmits the information for the detected rotation direction to the signal generator 58.

The signal generator 58 generates an operation signal based on the information transmitted from the linear movement detector 52, the rotational movement detector 54, and the movement direction detector 56, and transmits the generated operation signal to the control unit 10. In the present invention, when the linear movement detector 52 detects a linear movement of the object, the signal generator 58 generates an operation signal for the linear movement, and generates an operation signal for a rotational movement when the rotational movement detector 54 detects the rotational movement of the object. When the linear movement and the rotational movement of the object are detected at the same detection timing, the signal generator 58 generates an operation signal for the rotational movement. In addition, when generating the operation signal for the linear movement or the operation signal for the rotational movement and outputting the generated operation signal to the control unit 10, then the signal generator 58 initializes the results of detection by the linear movement detector 52, the rotational movement detector 54, and the movement direction detector 56. In this manner, the values detected by the linear movement detector 52, the rotational movement detector 54, and the movement direction detector 56 are initialized each time the operation signal is transmitted to the control unit 10.

The signal generator 58 generates an operation signal indicating a movement direction based on the information for the movement direction transmitted from the movement direction detector 56, and transmits the generated operation signal to the control unit 10. The signal generator 58 may generate an operation signal indicating the movement direction when the operation signal for the linear movement or the operation signal for the rotational movement is to be generated. The signal generator 58 may generate an operation signal indicating the movement direction irrespective of generation of the operation signal for the linear movement and the operation signal for the rotational movement. It should be noted that when an operation signal for the rotational movement is to be generated, the signal generator 58 generates an operation signal indicating a rotation direction as the operation signal indicating the movement direction.

The input device 24 is configured in the above manner. The input device 24 detects a displacement of the object by the displacement detector 50. In the input device 24, the linear movement detector 52 detects a movement of a linear component of the object based on the value detected by the displacement detector 50, and the rotational movement detector 54 detects a movement of a rotational component of the object based on the value detected by the displacement detector 50. Moreover, in the input device 24, the movement direction detector 56 detects a movement direction of the object (a movement direction of a vertical, horizontal, or slanted liner component, and a movement direction of a clockwise or counterclockwise rotational component) based on the value detected by the displacement detector 50. The movement direction detector 56 detects a displacement along the X axis, a displacement along the Y axis orthogonal to the X axis, a rotational displacement around the Z axis orthogonal to the X axis and the Y axis. The movement direction detector 56 also detects whether the displacement with respect to each of the axes is a displacement amount in a positive direction or a displacement amount in a negative direction (i.e., in the opposite direction of the positive direction), to detect a movement direction. The signal generator 58 generates an operation signal based on the detected result. The input device 24 performs detection control on the linear movement and detection control on rotational movement in parallel to each other.

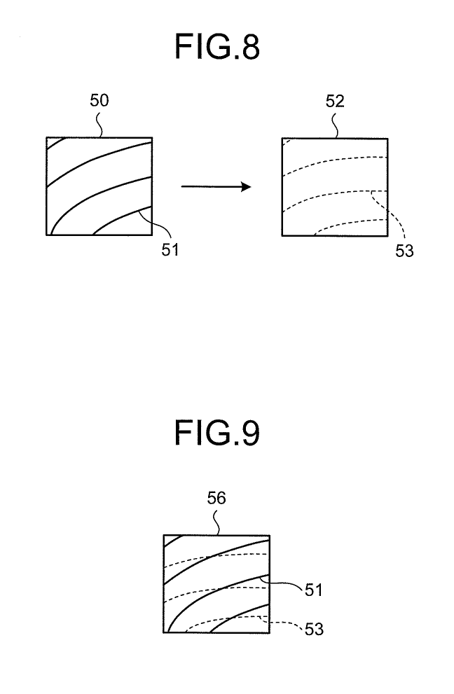

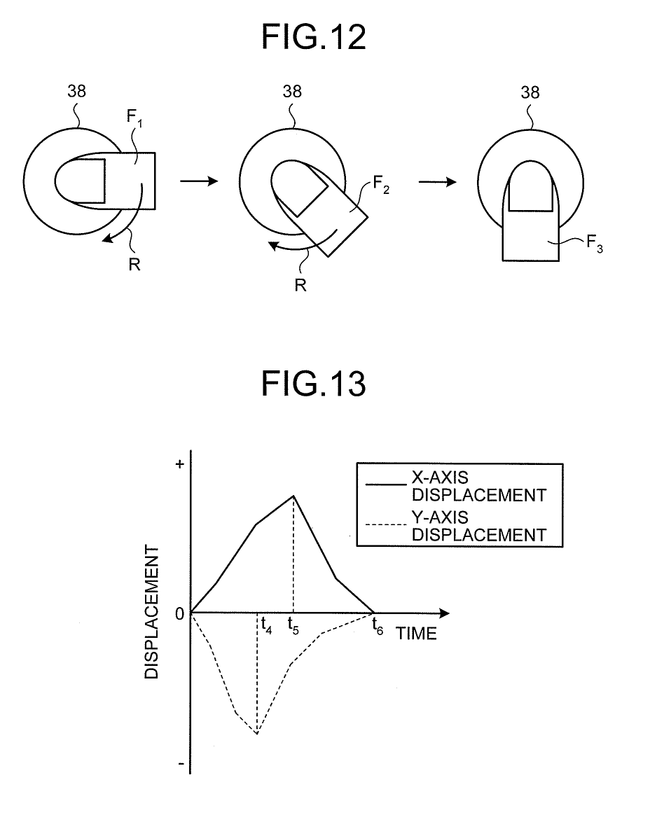

Next, the operation of detecting the rotational operation of the input device 24 will be explained with reference to FIG. 6, and FIG. 8 to FIG. 13. FIG. 8 to FIG. 13 are explanatory diagrams for explaining an operation of the input device. FIG. 8 to FIG. 10 are diagrams schematically illustrating an analysis method for analyzing an image on the touch surface detected by the displacement detector 50. FIG. 11 is a graph illustrating a relationship between the result of detecting a displacement amount and a time. FIG. 12 is an explanatory diagram for explaining another example of the input operation, and FIG. 13 is a graph illustrating a relationship between the result of detecting a displacement amount and a time. FIG. 11 and FIG. 13 plot a displacement amount on the Y axis and plot a time on the X axis. In FIG. 11 and FIG. 13, a displacement in the X-axis direction in FIG. 6 is detected as an X-axis displacement, and a displacement in the Y-axis direction in FIG. 6 is detected as a Y-axis displacement. That is, a displacement from the right-to-left direction in FIG. 6 is detected as a positive displacement in the X-axis direction, and a displacement in the upper direction in FIG. 6 is detected as a positive displacement in the Y-axis direction.

As illustrated in FIG. 6, when the finger F₁ touching the touch surface 38 rotates in the R direction (clockwise) to move up to the finger F₂, specifically, when the finger rotates about 45° in the clockwise direction, the input device 24 acquires an image at each given time by the displacement detector 50, acquires an image 50 of the finger F₁ touching the touch surface, and acquires an image 52 of the finger F₂ touching the touch surface. The image 50 is a fingerprint pattern 51 of the finger F₁, and the image 52 is a fingerprint pattern 53 of the finger F₂. The image 50 and the image 52 are images at the same portion on the touch surface 38 and images at a portion near the center of the touch surface. The fingerprint patterns 51 and 53 schematically represent only feature portions in part of the fingerprint of the finger.

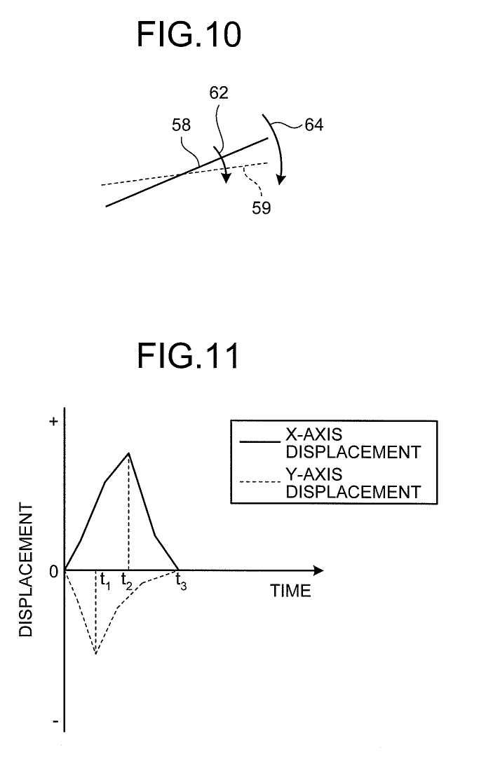

The rotational movement detector 54 acquires the image 50 and the image 52 from the displacement detector 50, and compares the fingerprint pattern 51 with the fingerprint pattern 53. Specifically, as illustrated in FIG. 9, the rotational movement detector 54 creates an image 56 in which the fingerprint pattern 51 and the fingerprint pattern 53 are superimposed on each other. Furthermore, the rotational movement detector 54 calculates movement amounts of corresponding feature points in the fingerprint pattern 51 and the fingerprint pattern 53. For example, as illustrated in FIG. 10, the rotational movement detector 54 calculates a line 58 obtained through linear approximation of the feature points of the fingerprint pattern 51 and a line 59 obtained through linear approximation of the feature points of the fingerprint pattern 53, and calculates a movement amount 62 on the center side of the touch surface 38 and a movement amount 64 on the outer edge side of the touch surface 38. The rotational movement detector 54 compares the detected movement amount 62 and movement amount 64, and determines that the object has rotated when a difference between the movement amounts is a give value or more (or the movement amount 64 is larger than the movement amount 62 by a given value or more in terms of a ratio of the movement amounts).

In this manner, by comparing the movement amount of the feature points on the center side of the touch surface 38 and the movement amount of the feature points on the outer edge side thereof, the rotational movement detector 54 can determine whether the object has rotated. It should be noted that the feature point may be a single point or a plurality of points. As illustrated in FIG. 10, a plurality of feature points are used to detect feature points of the object as a line, and a shape of the object upon the start of the movement is compared with a shape of the object upon the end of the movement, which enables to more appropriately detect whether the object has rotated.

In addition, by comparing the movement amount of the feature points on the center side of the touch surface 38 and the movement amount of the feature points on the outer edge side thereof, the rotational movement detector 54 can determine whether the object has rotated and detect the rotation of the object without calculating an actual center of the rotation. The rotational movement detector 54 may analyze the images or compare the feature points, to detect the center of the rotation of the object and detect the rotation of the feature points around the center of the rotation. When the rotation angle becomes a give value or more, the rotational movement detector 54 detects the input as a rotational operation.

A method of detecting a rotation by the rotational movement detector 54 is not limited to the method as above. The rotational movement detector 54 may detect the movement of the object by separating the movement into two-axis direction, the X-axis direction and the Y-axis direction, and determine whether the movement of the object is a rotational movement based on the result of detection. When the rotational movement from the position of the finger F₁ to the position of the finger F₂ illustrated in FIG. 6 is input, the rotational movement detector 54 detects the movement of the feature points of the finger by separating the movement into a movement in the X-axis direction and a movement in the Y-axis direction. When detecting the movement of the finger in FIG. 6 by separating the movement into the movement in the X-axis direction and the movement in the Y-axis direction, the rotational movement detector 54 detects the movements as illustrated in the graph of FIG. 11. The graph illustrated in FIG. 11 represents instantaneous values of movement amounts upon each detection (movement amount to the position of the line), and the area of the graph represents a movement amount from the start of the input to the end thereof. FIG. 11 is illustrated in such a manner that the movement is started at time 0 and the movement is ended at time t₃. When the rotational movement from the position of the finger F₁ to the position of the finger F₂ is input, the movement in the X-axis direction is detected as a positive value and the movement in the Y-axis direction is detected as a negative value. In addition, when the rotational movement from the position of the finger F₁ to the position of the finger F₂ is input, an absolute value of a displacement amount in the X-axis direction reaches to the maximum at time t₂, and an absolute value of a displacement amount in the Y-axis direction reaches to the maximum at time t₁. In this manner, when the rotational operation is input, a relative relationship between the movement amount of the feature points in the X-axis direction and the movement amount thereof in the Y-axis direction changes depending on a rotation angle. Therefore, timings at which displacements along the axes become maximum are shifted by a given time.

A magnitude of the detected displacement amount and a shift amount of the timings at which the displacement amount is the maximum change depending on the rotation amount and rotation direction of the finger. However, it remains unchanged that the timing at which the displacement amount becomes the maximum is shifted, and that an increasing and decreasing pattern of the displacement along each of the axes becomes a different pattern.

For example, as illustrated in FIG. 12, when an operation of rotational movement of the finger from the position of the finger F₁, passing through the position of the finger F₂, to the position of the finger F₃ in the R direction (operation of rotating the finger 90° in the R direction) is input, the rotational movement detector 54 detects the movements of the finger as illustrated in the graph of FIG. 13. FIG. 13 is illustrated in such a manner that the movement is started at time 0 and the movement is ended at time t₆. Similarly, when the rotational movement from the position of the finger F₁ to the position of the finger F₃ is input, the movement in the X-axis direction is detected as a positive value and the movement in the Y-axis direction is detected as a negative value. In addition, when the rotational movement from the position of the finger F₁ to the position of the finger F₃ is input, an absolute value of a displacement amount in the X-axis direction reaches to the maximum at time t₅, and an absolute value of a displacement amount in the Y-axis direction reaches to the maximum at time t₄. When the rotation angle of the finger becomes large as illustrated in FIG. 12 and FIG. 13, the time required for input and the detected movement amount in the X-axis direction and movement amount in the Y-axis direction change, however, timings at which displacements along the axes become maximum are shifted by a given time, similarly to the case of FIG. 11.

The rotational movement detector 54 uses the relation to detect the movement of the object by separating the movement into a movement in the X-axis direction and a movement in the Y-axis direction. By comparing change patterns of the displacement amounts, the rotational movement detector 54 can detect whether the object has rotated. As for the movement of the object, in the case of the linear movement, because a movement pattern (increasing and decreasing pattern of the displacement amount) in the X-axis direction and a movement pattern (increasing and decreasing pattern of the displacement amount) in the Y-axis direction are in a proportional relation to each other, the timings at which the displacements of the axes are maximum become identical. Therefore, the comparison of the movement patterns of the axes enables to determine whether the movement is the rotational movement or the linear movement.

In the input device 24, the displacement detector 50 may specify feature points used to detect the rotational movement and calculate information for movement of the feature points, and the rotational movement detector 54 may determine whether it is the rotational movement based on the result of calculation by the displacement detector 50.

The input device 24 and the movement direction detector 56 can detect a rotation direction by combination patterns of positive or negative movement in the X-axis direction and positive or negative movement in the Y-axis direction, and can also detect a movement angle of the linear movement based on the ratio between the movement amount in the X-axis direction and the movement amount in the Y-axis direction.

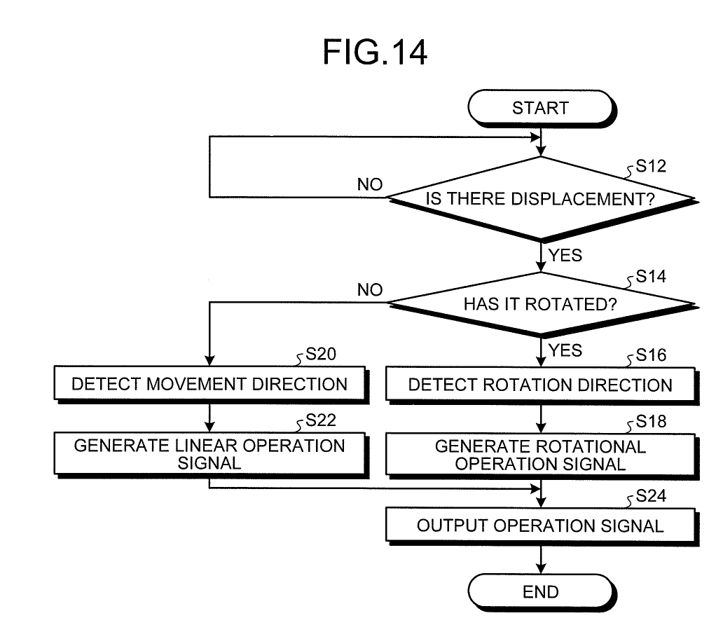

Next, the operation when the mobile phone terminal 1 receives an operation to the input device will be explained below. FIG. 14 is a flowchart illustrating one example of the operation of the mobile phone terminal. Each operation of the mobile phone terminal 1 illustrated in FIG. 14 is processed through transmission/reception of information in both the processing unit 36 of the input device 24 and the control unit 10.

First, in the mobile phone terminal 1, at Step S12, the displacement detector 50 of the input device 24 determines whether there is a displacement. That is, the displacement detector 50 determines whether the object touches the touch surface 38 and the operation is input. In the present embodiment, whether there is a displacement is determined by the displacement detector 50 based on whether the displacement is a given value or more. However, it may be determined based on whether at least one of the linear movement detector 52 and the rotational movement detector 54 detects the movement. When it is determined that there is no displacement (No at Step S12), the mobile phone terminal 1 proceeds to Step S12. That is, the mobile phone terminal 1 repeats the process at Step S12 until it is detected that the object touches the touch surface 38 and the operation is input.

When it is determined that there is a displacement (Yes at Step S12), the mobile phone terminal 1 determines whether the object has rotated at Step S14. That is, when it is determined that the operation is input through the input device 24, the mobile phone terminal 1 determines whether the input operation is the rotational operation. Whether it is the rotational operation is determined based on whether the rotational movement detector 54 detects the rotational operation.

When it is determined that the object has rotated (Yes at Step S14), that is, when it is determined that the input operation is an operation of rotational movement, the mobile phone terminal 1 detects a rotation direction at Step S16. The rotation direction is detected by the movement direction detector 56. When the rotation direction is detected at Step S16, the mobile phone terminal 1 generates a rotational operation signal (operation signal for a rotational movement) at Step S18. The rotational operation signal is generated by the signal generator 58 based on the result of detecting the rotational movement detected by the rotational movement detector 54 and the result of detecting the rotation direction detected by the movement direction detector 56. When the rotational operation signal is generated at Step S18, the mobile phone terminal 1 proceeds to Step S24.

When it is determined that the object has not rotated (No at Step S14), that is, when it is determined that the input operation is an operation of the linear movement, the mobile phone terminal 1 detects a movement direction at Step S20. The movement direction is detected by the movement direction detector 56. When the movement direction is detected at Step S20, the mobile phone terminal 1 generates a linear operation signal (operation signal for a linear movement) at Step S22. The linear operation signal is generated by the signal generator 58 based on the result of detecting the linear movement detected by the linear movement detector 52 and the result of detecting the movement direction detected by the movement direction detector 56. When the linear operation signal is generated at Step S22, the mobile phone terminal 1 proceeds to Step S24.

When the operation signal is generated at Step S18 or Step S22, the mobile phone terminal 1 outputs the operation signal generated by the input device 24 to the control unit 10, at Step S24. The control unit 10 provides the control corresponding to the input operation signal based on the input operation signal and the activated various functions. That is, the control unit 10 loads and executes the input processing program 9C determines the process to be executed based on the processing condition table 9E and the operation signal, and executes the determined process (control). When the operation can be input, the mobile phone terminal 1 repeats the processes in the flowchart illustrated in FIG. 14 and repeats detection of the operation input to the input device 24.

The mobile phone terminal 1 detects the operation input to the input device 24 through the processes illustrated in FIG. 14, to enable both the operation of linearly movement of the object such as the finger and the operation of rotational movement of the object to be detected as the operations. Thus, the input device 24 detects the operation of rotational movement in addition to the operation of linear movement of the object so that the detectable operations increase. That is, processes capable of being executed by inputting operations to the input device 24 increase. This allows further more input operations to execute processes through the input unit 3. Moreover, the rotational movement can be detected in addition to the linear movement through the internal process in the input device 24, thus increasing the operation that can be input without increasing other devices.

Because it is intuitively easy to input the rotational operation, it can be input more easily than an input operation in combination of a plurality of operations. Moreover, the rotational movement becomes detectable, which allows an easy input of an intuitive operation. For example, by associating the process of rotating a display image with the operation of the rotational movement, the display image can be rotated through an input of the operation of the rotational movement to the input device 24.

By detecting the movement direction by the movement direction detector 56 as well as the rotational movement like the embodiment, a different process can be executed in each rotation direction of the rotational operation. This makes it possible to input more types of operation through the rotational operation.

The mobile phone terminal 1 according to the present embodiment is configured to detect the rotational operation and the linear operation based on a difference between an input start of the operation and an input end thereof. Therefore, even if an input of the object is started at any angle, the rotational movement can be detected.

In the embodiment, priority is given to the detection of the rotation, however, the priority is not limited thereto. When the rotational movement and the linear movement are simultaneously detected, the mobile phone terminal 1 and the input device 24 may give the priority to the detection of the linear movement. That is, when operations detected as the rotational movement and the linear movement are input, which of the operations is to be preferentially detected may be adjusted through the setting.

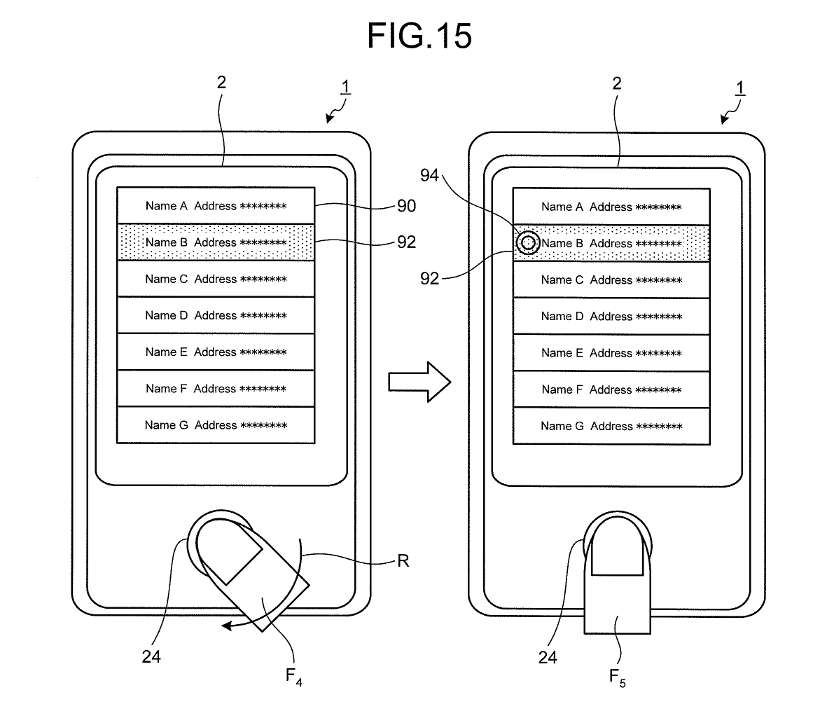

The control unit 10 can execute various processes as processes to be executed when the rotational operation signal is received. FIG. 15 is an explanatory diagram for explaining an operation of the mobile phone terminal. The mobile phone terminal 1 in FIG. 15 displays an image 90 as a list of incoming mails on the touch panel 2. A cursor 92 is displayed to indicate which incoming mail of the list is selected. The user inputs a rotational operation with his/her finger to the input device 24 when the image 90 and the cursor 92 appear thereon. Specifically, the user rotates the finger touching the input device 24 in the R direction from a position of finger F₄ to a position indicated by finger F₅, as illustrated in FIG. 15. When detecting the operation of rotational movement of the finger, the mobile phone terminal 1 sets the incoming mail specified by the cursor 92 as a lock state (protected state), and displays an icon 94 indicating the lock state superimposed on the image 90.

In this manner, in the example illustrated in FIG. 15, by associating a lock process of the incoming mail with the rotational operation, the lock process of the incoming mail can be performed without inputting operations for selecting a menu screen and selecting an item of the lock process or the like.

The embodiment has explained the case, as an example, where the rotational operation is set as the lock operation of the incoming mail, however, the present invention is not limited thereto, and therefore the rotational operation can be associated with various operations. For example, when the input of the rotational operation is detected, a process associated with a long-press operation of a key or an operation executed using a specific key may be performed. This allows an input of the operation only by rotating the finger, thus inputting the operation in less time than a time required for the long-press operation of the key. In addition, because the installation of a specific key can be eliminated, the configuration of the device can be made simple without decreasing the number of operations that can be input.

The rotational movement detector 54 preferably detects a rotation angle of the input rotational movement in addition to the detection of the input of the rotational movement. The input device 24 detects the rotation angle of the rotational operation input by the rotational movement detector 54, to enable a different operation to be allocated according to the rotation angle, and thus can input more types of operation through the rotational operation. For example, by setting different processes for cases where the operation is a rotation of 45° and the operation is a rotation of 90°, when the rotational operation is input, two different processes can be performed. For example, when the list of mails is displayed, a key lock process may be associated with a rotational movement of 90° and a mail lock process may be associated with a rotational movement of 45°.

The rotational movement detector 54 can detect a rotation angle using various methods. For example, when the rotation angle is detected using a difference between movement amounts of feature points, the rotation angle may be associated with the movement amount on the outer edge side. Alternatively, the mobile phone terminal 1 may calculate a center of rotation and then detect the rotation angle around the center. When the rotation angle is calculated using patterns of displacements in two axial directions orthogonal to each other, the rotation angle can be calculated based on the patterns of the displacements.

An operation to be input using a linear movement of the input device includes various operations that can be input by a so-called pointing device such as mouse, joystick, and trackball, and a movement of cursor, a movement of pointer, and a scroll of a screen and the like are exemplified. In this manner, the input device according to the present embodiment detects both the linear movement and the rotational movement as the operations, so that various operations can be input using a single input device. This enables more operations to be input with the simple operation.

The input device 24 preferably processes the linear movement detector 52 and the rotational movement detector 54 in parallel like the present embodiment. This enables the processing time to be reduced.

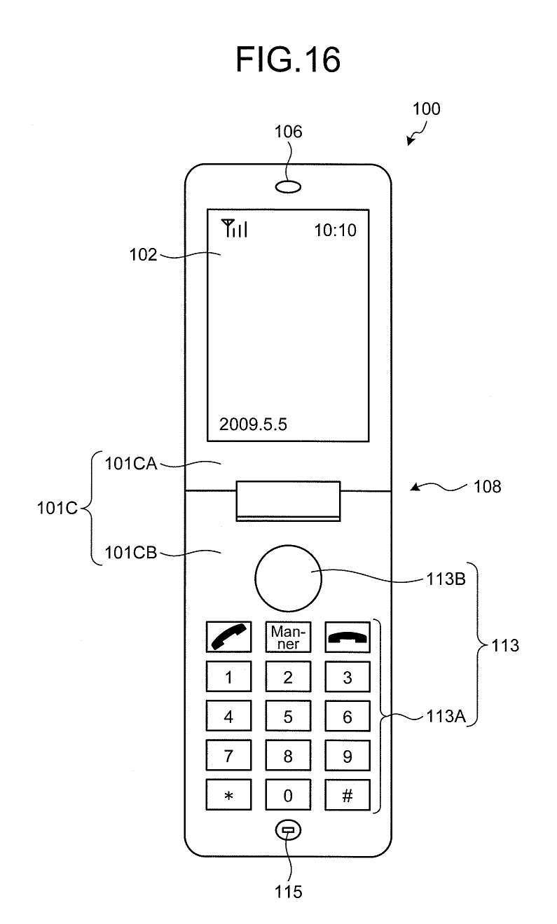

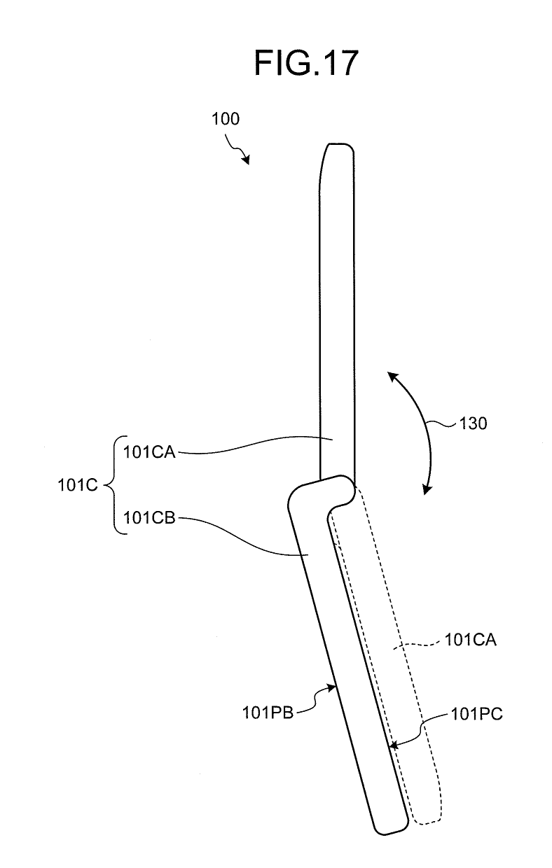

In the embodiment, the mobile phone terminal has the touch panel, however, the present invention is not limited thereto. FIG. 16 is a front view illustrating a schematic configuration of a mobile phone terminal according to another embodiment, and FIG. 17 is a side view of the mobile phone terminal illustrated in FIG. 16. A mobile phone terminal 100 illustrated in FIG. 16 and FIG. 17 is a mobile phone that includes a wireless communication function. The mobile phone terminal 100 has a housing 101C formed with a plurality of housings. Specifically, the housing 101C is formed with a first housing 101CA and a second housing 101CB which are openable/closable. That is, the mobile phone terminal 100 has folding housings. The housing of the mobile phone terminal 100 is not limited to this construction. For example, the housing of the mobile phone terminal 100 may be slide type housings so that one housing and the other housing can mutually slide from a state in which both the housings are overlapped, may be a rotating type in which one of housings is rotated around its axis line along an overlapping direction, or may be such that both housings are coupled to each other via a two-axis hinge.

The first housing 101CA and the second housing 101CB are coupled to each other by a hinge mechanism 108 being a coupling portion. By coupling the first housing 101CA and the second housing 101CB with the hinge mechanism 108, the first housing 101CA and the second housing 101CB can relatively pivot around the hinge mechanism 108 in directions of arrow 130 in FIG. 17. The first housing 101CA and the second housing 101CB can move from a position indicated by the solid line in FIG. 17 to a position indicated by the dotted line in FIG. 17, that is, a position where they are folded, around the hinge mechanism 108.

The first housing 101CA is provided with a display 102 illustrated in FIG. 16 as a display unit. The display 102 displays a standby image when the mobile phone terminal 100 awaits reception, and displays a menu image used to assist the operations of the mobile phone terminal 100. The first housing 101CA is also provided with a receiver 106 being an output unit that outputs speech during a telephone call using the mobile phone terminal 100.

The second housing 101CB is provided with a plurality of operation keys 113A on the other end of the phone, which are used to input a telephone number of the party and a text of a mail. An input device 113B is provided between the hinge 108 and the operation keys 113A. The operation keys 113A and the input device 113B form an operating unit 113 of the mobile phone terminal 100. Provided in the second housing 101CB is a microphone 115 being a speech acquiring unit that receives speech during a telephone call using the mobile phone terminal 100. The operating unit 113 is provided on an operating surface 101PC of the second housing 101CB as illustrated in FIG. 17. The face opposite to the operating surface 101PC is a back face 101PB of the mobile phone terminal 100.

An antenna is internally provided in the second housing 101CB. The antenna is a transmitting and receiving antenna used for wireless communication, and is used for transmission and reception of radio waves (electromagnetic waves) related to telephone call and electronic mail and so on between the mobile phone terminal 100 and a base station. The microphone 115 is provided on the second housing 101CB. The microphone 115 is located on the side of the operating surface 101PC of the mobile phone terminal 100 as illustrated in FIG. 17.

The mobile phone terminal 100 is provided with the input device 113B as well as the operation keys 113A so that the various operations as explained above can be input through the input device 113B. For example, the input device 113B can be used as a direction keys, an OK button, and other special keys so as to easily perform selection and decision of a menu displayed on the display 102 and perform scrolling or the like of a screen.

In the embodiment, the linear movement and the rotational movement are discretely detected, however, the present invention is not limited thereto. The mobile phone terminal (electronic device) may determine an input operation based on the linear movement and the rotational movement detected by the input device, irrespective of criteria to determine operations. In the embodiment, the operation signal is generated by the input device, however, the input device may detect only the displacement of an object (that is, information for an image on the touch surface or change information for a position of a feature point), and the control unit may detect the linear movement and the rotational movement.

The input unit (input device and the control therefor) can be used for various electronic devices as explained above. For example, the input unit is preferably used for mobile electronic devices, such as mobile phone terminals. The mobile electronic devices such as the mobile phone terminals are getting smaller and thinner in size. Therefore, a single input unit that allows various inputs without a broad install area is suitable.

The electronic device according to the present invention is capable of inputting a required operation with a simple and quick operation.

What is claimed is:

1. An electronic device comprising:
a housing;
a touch surface exposed to a surface of the housing;
a displacement detector configured to detect a displacement of an object touching the touch surface based on a light from the touch surface;
a rotational movement detector configured to detect a rotational movement of the object based on the displacement detected by the displacement detector;
a linear movement detector configured to detect a linear movement of the object based on the displacement detected by the displacement detector;
a signal generator configured to generate a first operation signal corresponding to the rotational movement detected by the rotational movement detector and to generate a second operation signal corresponding to the linear movement detected by the linear movement detector; and
a control unit configured to control an operation to be performed based on the first operation signal and an operation to be performed based on the second operation signal.

2. The electronic device according to claim 1, wherein
the rotational movement detector is configured to detect the rotational movement of the object when the displacement in an outer edge portion of the touch surface is larger by a predetermined value than the displacement at a center portion thereof.

3. The electronic device according to claim 1, wherein
the rotational movement detector is configured to detect the rotational movement of the object when the displacement has a deviation in increase and decrease in two orthogonal directions.

4. The electronic device according to claim 1, wherein
the control unit is configured to control a first operation in response to the first operation signal and control a second operation in response to the second operation signal.

5. The electronic device according to claim 1, wherein
the rotational movement detector is configured to detect an angle at which the object rotates.

6. The electronic device according to claim 1, wherein
the signal generator is configured to generate the first operation signal when the displacement detector detects the displacement of the object and the rotational movement detector detects the rotational movement of the object, and generate the second operation signal when the displacement detector detects the displacement of the object and the rotational movement detector does not detect the rotational movement of the object.

7. The electronic device according to claim 1, wherein
the displacement detector is configured to acquire continuously images on the touch surface, process the images, detect a displacement of a feature point of the object, and determine the detected displacement of the feature point as the displacement of the object.

8. The electronic device according to claim 1, further comprising:
a light source configured to irradiate the light in an invisible region to the touch surface, wherein
the displacement detector is configured to detect the displacement of the object based on the light irradiated by the light source and reflected by the touch surface.

9. The electronic device according to claim 1, further comprising:
a movement direction detector configured to detect a movement direction of the object based on the displacement of the object detected by the displacement detector, wherein
the signal generator is configured to generate the first operation signal further based on the movement direction detected by the movement direction detector and generate the second operation signal further based on the movement direction detected by the movement direction detector.

10. The electronic device according to claim 9,
wherein the signal generator is configured to generate either one of the first operation signal with information for the rotation direction added thereto and the second operation signal with information for the movement direction added thereto.

11. The electronic device according to claim 1, wherein
the object is either one of a finger and a tip of a rod-shaped object.
